(19) United States
(12) Patent Application Publication
(10) Pub. No.: US 2026/0183800 A1
(43) Pub. Date: Jul. 2, 2026

(54) AUTOMATIC SORTING AND COLLECTION APPARATUS FOR TARGET COLLECTION OBJECTS

(71) Applicant: Inobus, INC., Seoul (KR)

(72) Inventors: Jin Hyuk JANG, Seoul (KR); Ji Su KIM, Seoul (KR); Jae Hong OH, Seoul (KR); Gyu Hwa JEONG, Seoul (KR); Seong Jae KIM, Seoul (KR)

(21) Appl. No.: 19/318,495

(22) Filed: Sep. 4, 2025

(30) Foreign Application Priority Data
Dec. 27, 2024 (KR) 10-2024-0199078

(51) Int. Cl. B07C 5/34

(52) U.S. Cl. CPC B07C 5/3408; B07C 2501/0054

(57) ABSTRACT

An automatic sorting and collection apparatus for target collection objects includes: a main body housing having an inlet for user input of target collection objects and an outlet for discharging non-target collection objects; a sorting assembly including an inner plate inside the inlet forming a detection area wherein a molten body input is settled, and a first driving motor providing power to rotate the inner plate forward and backward; a target determination unit inside the housing that captures an object in the detection area and determines whether it is a target collection object; and a collection box inside the housing to capture the target collection objects. The sorting assembly controls the first driving motor to rotate the inner plate forward to drop target collection objects into the collection box, or backward to discharge non-target collection objects by dropping the non-target collection objects toward the outlet based on the determination result.

### CROSS-REFERENCE TO RELATED APPLICATION

This application claims priority under 35 U.S.C. § 119 to Korean Patent Application No. 10-2024-0199078 filed on Dec. 27, 2024, in the Korean Intellectual Property Office, the disclosure of which is incorporated herein by reference in its entirety.

### BACKGROUND

### (A) Technical Field

The present disclosure relates to an automatic sorting and collection apparatus, and more particularly, to an automatic sorting and collection apparatus for target collection objects capable of automatically sorting and collecting target collection objects and automatically discharging non-target collection objects.

### (B) Background Art

As interest in environmental protection increases worldwide, the separation and collection of recyclables has become a very important task. In particular, although PET bottles are easy to recycle, the PET bottles are often collected with labels attached, requiring additional processing during the recycling process.

Most of the conventional methods of collecting PET bottles have been performed manually. According to the conventional methods, when users put PET bottles into a collection bin, workers directly check the collection bin and sort the PET bottles with and without labels removed. The manual method has the problems of not only requiring high labor costs but also having low work efficiency and inconsistent classification accuracy, which depends on the worker's condition.

In addition, some automatic collection apparatuses have been developed, but these apparatuses simply detect whether the PET bottles have been input, and have limitations in accurately identifying whether the input objects are the PET bottles to be collected. As a result, there was a problem in that PET bottles without labels removed, which are non-target collection objects, or objects other than the PET bottles were collected, requiring additional sorting work during the recycling process.

In addition, the existing collection apparatuses had the problem of frequent mechanical failures. In particular, when users input foreign substances other than the PET bottles or operated an inlet with excessive force, the apparatus was often damaged, which increased repair costs and lowered an operating rate of the collection apparatus.

Therefore, a method for solving these problems is required.

[Related Art Document]

[Patent Document]

Korean Laid-open Patent Publication No. 10-2009-0029154

### SUMMARY OF THE DISCLOSURE

The present disclosure is an invention devised to solve the above-described problems of the related art, and provides an automatic sorting and collection apparatus for target collection objects capable of accurately distinguishing between target collection objects and non-target collection objects to automatically sort and collect the target collection objects and the non-target collection objects, and preventing damage to the apparatus and minimizing malfunctions.

The problems of the present disclosure are not limited to the above-described problems, and other problems that are not described may be obviously understood by those skilled in the art from the following specification.

An automatic sorting and collection apparatus for target collection objects of the present disclosure to achieve the above-described object includes: a main body housing that has an inlet formed so that a user inputs the target collection objects, and an outlet formed so that non-target collection objects input through the inlet are discharged; a sorting assembly that includes an inner plate provided inside the inlet and forming a detection area in which a molten body input through the inlet is settled on an upper portion, and a first driving motor providing a driving force so that the inner plate rotates in forward and backward directions; a target determination unit that is provided inside the main body housing to capture an object positioned in the detection area and determines whether the captured object is a target collection object; and a collection box that is provided inside the main body housing to capture the target collection objects, wherein the sorting assembly may control the first driving motor so that the inner plate rotates in the forward direction, based on the determination result of the target determination unit, to collect the target collection objects by dropping the target collection objects toward the collection box, and control the first driving motor so that the inner plate rotates in the backward direction, to discharge non-target collection objects by dropping the non-target collection objects toward the outlet.

In addition, the sorting assembly may further include: a sensor dog that is provided at a preset position of the inner plate; and a photo sensor array that detects a position of the sensor dog.

The photo sensor array may also include: a fixed position photo sensor that detects the sensor dog while the inner plate is in the fixed position; and an export photo sensor that detects the sensor dog while the inner plate rotates in the backward direction from the fixed position.

In this case, the sorting assembly may further include a first torque limiter that is provided between the first driving motor and the inner plate to cause a motor shaft of the first driving motor to idle when an external force exceeding a preset torque value is applied.

The automatic sorting and collection apparatus may further include: a door assembly selectively opening and closing the inlet.

The door assembly may include: a slide door that is formed to be movable up and down, and shields the inlet while moving to the upper portion, and opens the inlet while moving to a lower portion; a guide rail that provides a guide for moving the slide door up and down; and a second driving motor that provides a driving force to move the slide door up and down along the guide rail.

Meanwhile, the door assembly may further include a second torque limiter that is provided between the second driving motor and the slide door to cause a motor shaft of the second driving motor to idle when an external force exceeding a preset torque value is applied.

The door assembly may further include a pair of door photo sensors that detect upward and downward movement positions of the slide door.

In addition, the target determination unit may include: a capturing module that captures an object positioned in the detection area; and an AI processor that analyzes an image captured by the capturing module to determine whether the object positioned in the detection area is the target collection object.

The target collection object may be a PET bottle with a label removed.

According to the automatic sorting and collection apparatus for target collection objects of the present disclosure for solving the above-described problem, by automatically capturing and determining the target collection objects in the detection area when the target collection objects are input and appropriately collecting or discharging the target collection objects, it is possible to accurately and efficiently sort and collect the target collection objects without the intervention of a worker.

In addition, according to the present disclosure, by automatically controlling the movement path of the target collection objects and the non-target collection objects through the forward and backward rotation of the inner plate to collect only the target collection objects in the collection box and automatically discharge the non-target collection objects through the outlet, it is possible to improve the purity of the collected objects.

In addition, according to the present disclosure, by adopting the method of accurately determining and then sorting objects in the detection area to eliminate the need for additional sorting work on the collected objects, it is possible to reduce the overall recycling processing cost.

Furthermore, according to the present disclosure, by performing the determination on the input objects while the input objects are stopped in the detection area and performing the sorting operation based on the result, it is possible to minimize the errors that may occur when identifying the moving objects and improving the accuracy of sorting.

The effects of the present disclosure are not limited to the above-described effects, and other effects that are not described may be obviously understood by those skilled in the art from the claims.

### BRIEF DESCRIPTION OF THE DRAWINGS

FIG. 1 is a diagram illustrating an appearance of an automatic sorting and collection apparatus for target collection objects according to an embodiment of the present disclosure.

FIG. 2 is a diagram illustrating an inside of the automatic sorting and collection apparatus for target collection objects according to an embodiment of the present disclosure.

FIG. 3 is a diagram illustrating a sorting assembly viewed from a front upper portion in the automatic sorting and collection apparatus for target collection objects according to an embodiment of the present disclosure.

FIG. 4 is a diagram illustrating a sorting assembly viewed from a rear lower portion in the automatic sorting and collection apparatus for target collection objects according to an embodiment of the present disclosure.

FIGS. 5 to 7 are diagrams illustrating a process of sorting target collection objects through the automatic sorting and collection apparatus for target collection objects according to an embodiment of the present disclosure.

### DETAILED DESCRIPTION

In this specification, when a component (or region, layer, section, etc.) is referred to as being “on”, “connected to”, or “coupled to” another component, it means that the component may be directly arranged/connected/coupled on/to the other component, or a third component may be arranged between them.

The same drawing numbers refer to the same components. In addition, in drawings, thicknesses, ratios, and dimensions of components are exaggerated for efficient description of technical contents.

“And/or” includes all combinations of one or more that the associated components may define.

The terms used in the specification, ‘first’, ‘second’, etc., can be used to describe various components, but the components are not to be construed as being limited to the terms. The terms are only used to distinguish one component from another component. For example, the first component may be named the second component and the second component may also be similarly named the first component, without departing from the scope of the present disclosure. Singular expressions are intended to include plural expressions unless the context clearly indicates otherwise.

In addition, the terms such as “below,” “underside,” “above,” and “upper” are used to describe the relationship between the components depicted in the drawings. The above terms are relative concepts and are described based on the directions indicated in the drawings.

Unless defined otherwise, all terms (including technical and scientific terms) used herein have the same meaning as generally understood by one of ordinary skill in the art to which the present disclosure pertains. In addition, the terms such as terms defined in commonly used dictionaries should be interpreted as having a meaning consistent with their meaning in the context of the relevant art, and are explicitly defined herein unless interpreted in an ideal or overly formal sense.

It should be further understood that the term “include” or “have” specifies the presence of features, numerals, steps, operations, components, parts described in the present specification, or combinations thereof, but does not preclude the presence or addition of one or more other features, numerals, steps, operations, components, parts, or combinations thereof.

Hereinafter, the embodiments of the present disclosure will be described in detail with reference to the accompanying drawings.

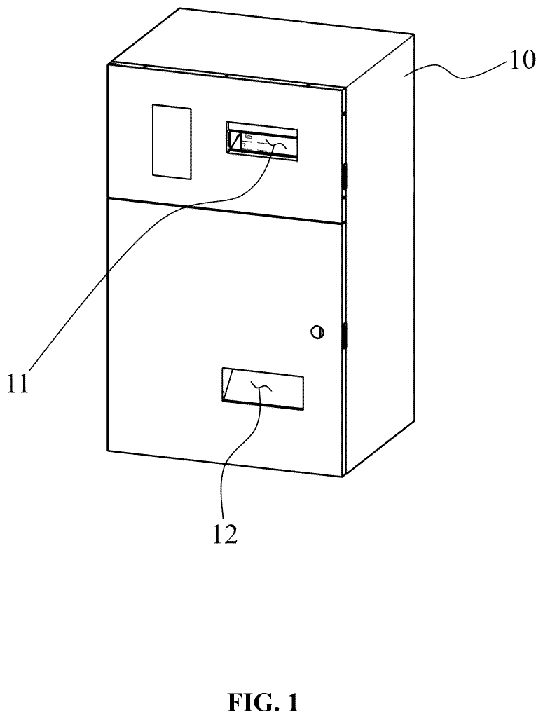

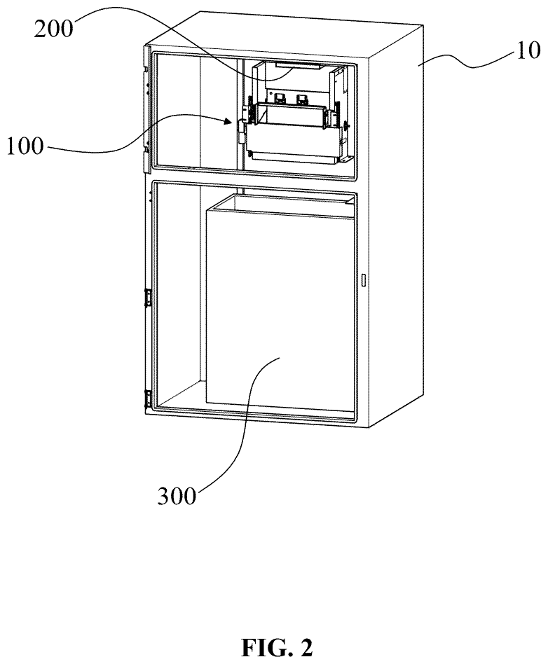

FIG. 1 is a diagram illustrating an appearance of an automatic sorting and collection apparatus for target collection objects according to an embodiment of the present disclosure, and FIG. 2 is a diagram illustrating the interior of the automatic sorting and collection apparatus for target collection objects according to an embodiment of the present disclosure.

As shown in FIG. 1 and FIG. 2, the automatic sorting and collection apparatus for target collection objects in the present embodiment may include a main body housing 10 forming the overall appearance.

The main body housing 10 may have openings formed in a front portion to facilitate an input of target collection objects and a discharge of non-target collection objects. Specifically, in the present embodiment, an inlet 11 through which a user may input the target collection objects and an outlet 12 through which the non-target collection objects are discharged to the outside may be formed in the main body housing 10.

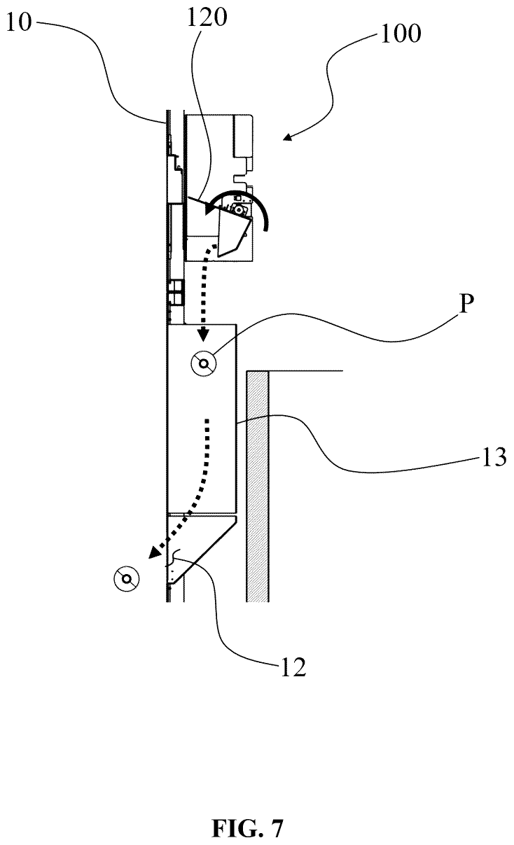

In addition, in the present embodiment, the inlet 11 may be positioned in an upper portion of the main body housing 10, and the outlet 12 may be positioned in a lower portion of the main body housing 10. In addition, in the present embodiment, a discharge guide 13 (see FIG. 7) may be provided inside the main body housing 10 to guide the non-target collection objects to be smoothly discharged toward the outlet 12.

A sorting assembly 100 for sorting the input objects may be provided inside the main body housing 10. The sorting assembly 100 may temporarily settle the objects input through an inlet 11 and move the objects to a collection box 300 side or an outlet 12 side, which will be described later, depending on whether the object is the target collection object.

In addition, in the present embodiment, a target determination unit 200 may be provided inside the main body housing 10 to determine whether the object settled in a detection area 121 is the target collection object.

Although not specifically illustrated, the target determination unit 200 in the present embodiment may include a capturing module that is positioned toward the detection area 121 to capture the object positioned in the detection area 121, and an AI processor that analyzes an image captured by the capturing module to determine whether the object is the target collection object.

In this case, the capturing module may include an image sensor such as a charge coupled device (CCD) or a complementary metal oxide semiconductor (CMOS), but is not limited only to this form.

In addition, the collection box 300 may be provided inside the main body housing 10 to capture an object determined to be the target collection object by the target determination unit 200. The collection box 300 is positioned at a lower portion of the sorting assembly 100, and may capture the target collection objects that drop from the sorting assembly 100 when the object that has been put into the sorting assembly 100 is determined to be a normal target collection object.

Meanwhile, in the present embodiment, the target collection objects may be a PET bottle with a label removed. Accordingly, the AI processor may analyze the image captured by the capturing module through a deep learning-based image recognition algorithm to determine whether the input object is the PET bottle and whether the label of the PET bottle has been removed.

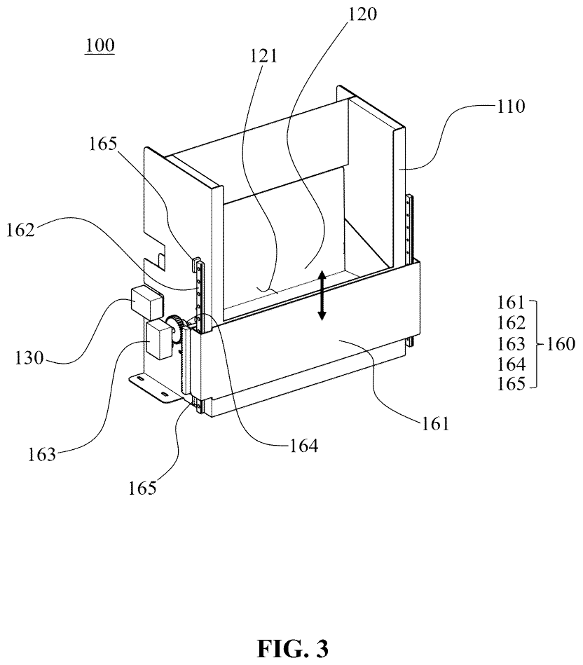

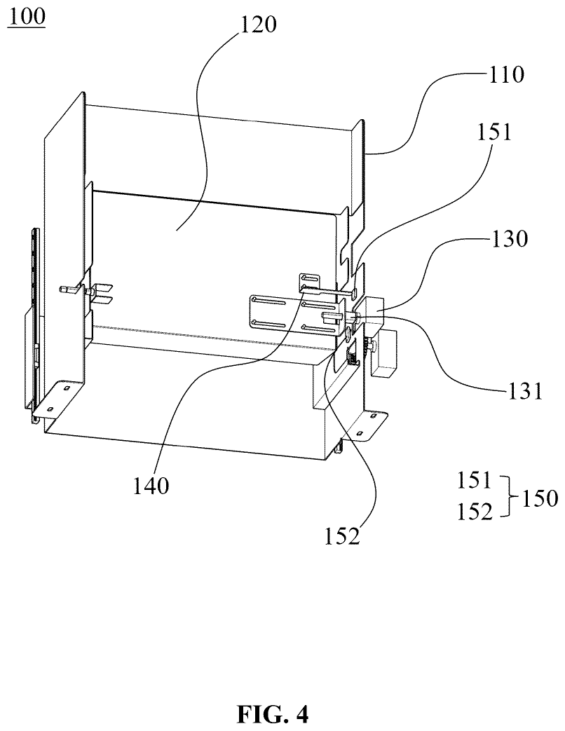

FIG. 3 is a diagram illustrating a view of the sorting assembly 100 from the front upper portion in the automatic sorting and collection apparatus for target collection objects according to an embodiment of the present disclosure, and FIG. 4 is a diagram illustrating a view of the sorting assembly 100 from a rear lower portion in the automatic sorting and collection apparatus for target collection objects according to an embodiment of the present disclosure.

As shown in FIGS. 3 and 4, the sorting assembly 100 in the present embodiment may include a sorting housing 110, an inner plate 120, a first driving motor 130, a first torque limiter 131, a sensor dog 140, a photo sensor array 150, and a door assembly 160.

The sorting housing 110 may form an overall appearance so that other components of the sorting assembly 100 may be mounted.

In the present embodiment, the sorting housing 110 may support a rotation axis of the inner plate 120 so that the inner plate 120 may rotate stably, and may prevent flow that may occur when the inner plate 120 rotates.

The inner plate 120 may be rotatably installed in the sorting housing 110, and the detection area 121 may be formed on an upper surface of the inner plate 120 where the object input through the inlet 11 is settled.

The detection area 121 is an area formed by the upper surface of the inner plate 120, and the upper surface of the inner plate 120 may be formed to have a downward slope in the inner direction so that the input object may be stably settled without flowing. In addition, the detection area 121 may be formed with a sufficient area so that the target determination unit 200 may easily capture the input object.

The first driving motor 130 may provide a driving force to rotate the inner plate 120 in forward or backward direction.

The first driving motor 130 may be implemented as a step motor or a servo motor that may precisely control a rotation direction and a rotation angle, and may also be implemented as various types of motors such as a DC motor and a BLDC motor. However, the first driving motor 130 is not limited only to these types.

The first torque limiter 131 is installed between the first driving motor 130 and the inner plate 120 and may transmit power to the inner plate 120 side.

In this case, the first torque limiter 131 may cause a motor shaft of the first driving motor 130 to idle when an external force exceeding a preset torque value is applied to the inner plate 120. This may prevent the first driving motor 130 from being damaged even when the rotation of the inner plate 120 is impeded or an excessive load occurs.

The sensor dog 140 may be formed by protruding at a preset position of the inner plate 120, and in the case of the present embodiment, it is exemplified that the sensor dog 140 is installed on a rear side of the inner plate 120.

Such a sensor dog 140 may be used to detect the rotational position of the inner plate 120 by being detected by the photo sensor array 150 to be described later when the inner plate 120 rotates.

The photo sensor array 150 may include a plurality of photo sensors 151 and 152 that detect the position of the sensor dog 140.

Specifically, in the present embodiment, the photo sensor array 150 may include a fixed position photo sensor 151 that detects the sensor dog 140 while the inner plate 120 is in a fixed position, and an export photo sensor 152 that detects the sensor dog 140 while the inner plate 120 rotates in the backward direction from the fixed position.

Such a photo sensor array 150 may be implemented with various types of sensors such as a combination of an LED and a photodiode, an infrared sensor, and a photoelectric sensor, but is not limited only to this type.

The door assembly 160 is provided so as to selectively open and close the inlet 11 of the main body housing 10.

In addition, in the present embodiment, the door assembly 160 may include a slide door 161, a guide rail 162, a second driving motor 163, a second torque limiter 164, and a pair of door photo sensors 165.

The slide door 161 may be formed to be able to move up and down. Specifically, in the present embodiment, the slide door 161 is formed to be able to shield the inlet 11 while moving to the upper portion, and open the inlet 11 while moving to the lower portion.

The guide rail 162 may be coupled to the side of the slide door 161 to provide a guide so that the slide door 161 may move smoothly in the up and down direction.

The second driving motor 163 may provide a driving force to move the slide door 161 up and down along the guide rail 162.

In addition, the second torque limiter 164 is provided between the second driving motor 163 and the slide door 161, so that when the external force exceeding the preset torque value is applied, the motor shaft of the second driving motor 163 may be made to idle.

In addition, a pair of door photo sensors 165 may detect the upward and downward movement positions of the slide door 161, respectively. Through this, the present embodiment may accurately control the upward and downward movement of the slide door 161.

In addition, although not illustrated, in the present embodiment, an inlet sensor unit for the input of the target collection objects and the safety of the user may be additionally provided in the inlet 11.

In detail, the inlet sensor unit may include a transparent detection photo sensor and a limit switch, and when either of them detects the user's hand or body, the slide door 161 may be controlled to open immediately.

The transparent detection photo sensor may detect the target collection objects input through the inlet 11. When the user puts the target collection objects into the inlet 11 while the slide door 161 is open, the transparent detection photo sensor may detect the target collection objects and control the second driving motor 163 to close the slide door 161.

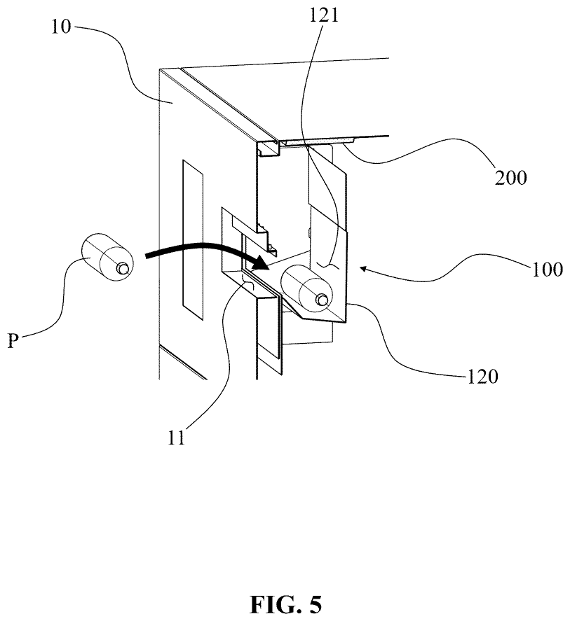

In this case, in the present embodiment, the target collection objects are exemplified as a transparent PET bottle P (see FIG. 5). Accordingly, the transparent detection photo sensor may be configured in combination with a reflector in consideration of the characteristics of the PET bottle P, and thus, the passage of the transparent objects may be accurately detected.

The limit switch may detect that a user forcibly inputs an object or the user's body, such as a hand, is caught, and in particular, in the present embodiment, the limit switch may operate in conjunction with a limit bracket provided on the upper portion of the inlet 11.

For example, when the user's body is forced upward by the slide door 161, the limit bracket positioned on the upper portion is pushed and moves to the upper portion, and may come into contact with the limit switch. Accordingly, the limit switch may detect this and control the slide door 161 to open immediately.

The present embodiment may prevent the user's hand or body from being caught on the inlet 11 through this double safety structure, and at the same time, accurately detect the input of the PET bottle P and automatically control the slide door 161.

Each component of the automatic sorting and collection apparatus for target collection objects according to the present embodiment have been described in detail, and the process of selecting and collecting target collection objects through the automatic sorting and collection apparatus for target collection objects according to the present embodiment will be described.

FIGS. 5 to 7 are diagrams illustrating the process of sorting target collection objects through the automatic sorting and collection apparatus for target collection objects according to an embodiment of the present disclosure.

First, as illustrated in FIG. 5, when a user wants to put an object such as the PET bottle P into the automatic sorting and collection apparatus for target collection objects, the slide door 161 of the door assembly 160 may first be lowered so that the inlet 11 may be opened.

Specifically, in this process, the second driving motor 163 is driven so that the slide door 161 is lowered along the guide rail 162. In this case, when the door photo sensor positioned at the lower portion of the pair of door photo sensors 165 detects the downward movement of the slide door 161, the operation of the second driving motor 163 may be stopped.

The object input through the inlet 11 may be settled in the detection area 121 formed on the upper surface of the inner plate 120 of the sorting assembly 100.

In this case, the slide door 161 may rise again to shield the inlet 11. When the door photo sensor positioned at the upper portion of the pair of door photo sensors 165 detects the upward movement of the slide door 161 during the process of the slide door 161 rising, the operation of the second driving motor 163 may be stopped.

Thereafter, the object settled in the detection area 121 may be captured by the capturing module of the target determination unit 200. In this case, the inner plate 120 may be kept stationary at the position where the fixed position photo sensor 151 detects the sensor dog 140.

The AI processor may analyze the image captured by the capturing module to determine whether the corresponding object is a PET bottle P with a label removed.

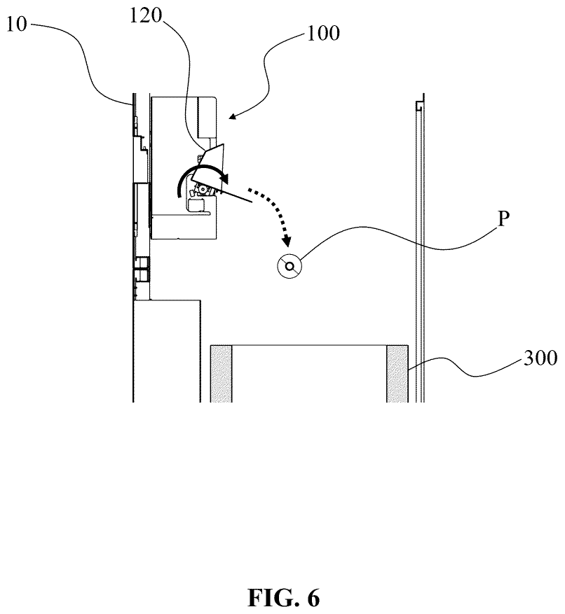

When the input object is the PET bottle P with a label removed, as illustrated in FIG. 6, the first driving motor 130 may rotate the inner plate 120 in the forward direction. As the inner plate 120 rotates in the forward direction, the PET bottle P that was settled in the detection area 121 may be dropped toward the collection box 300 and collected.

In addition, after the PET bottle P has dropped, the first driving motor 130 may rotate the inner plate 120 in the backward direction to return the inner plate 120 to the position where the fixed position photo sensor 151 detects the sensor dog 140.

On the other hand, when the input object is the PET bottle without a label removed or is not the PET bottle, as shown in FIG. 7, the first driving motor 130 may rotate the inner plate 120 in the backward direction from the fixed position. As the inner plate 120 rotates in the backward direction, the object that was settled in the detection area 121 may be dropped and discharged toward the outlet 12.

In addition, when the export photo sensor 152 detects the sensor dog 140 during the backward rotation of the inner plate 120, the first driving motor 130 may rotate the inner plate 120 in the forward direction again so that the fixed position photo sensor 151 may return to the position where it detects the sensor dog 140.

As described above, in these processes, the first torque limiter 131 and the second torque limiter 164 may prevent damage to each driving motor 130 and 163 by causing the motor shafts of the first driving motor 130 and the second driving motor 163 to idle when the excessive external force is applied to the inner plate 120 and the slide door 161, respectively.

In addition, in the present embodiment, a load amount photo sensor for detecting a load amount may be provided on an upper end of the collection box 300. The load amount photo sensor may be installed in a form such as crossing the upper end of the collection box 300 to detect the load amount of the PET bottle P inside the collection box 300.

The target determination unit 200 may monitor the loading state of the collection box 300 according to the detection result of the loading amount photo sensor. Accordingly, when the loading amount photo sensor detects that the PET bottle P is loaded above the set height, the target determination unit 200 may transmit a collection request signal to a manager's terminal, etc. In this way, the present embodiment may prevent problems in the collection operation due to the excessive loading of contents in the collection box 300.

Meanwhile, in the present embodiment, the target determination unit 200 may perform a sequential multi-step determination process on the input object. Specifically, the multi-stage determination process may sequentially perform a shape recognition step, a transparency analysis step, and a surface pattern analysis step.

In the shape recognition step, the target determination unit 200 may analyze the image captured by the capturing module to determine whether the outer shape of the input object matches the basic shape of the PET bottle.

To this end, the AI processor may analyze an aspect ratio of an object, whether the object is cylindrical, a shape of a neck, etc. When the input object does not match the basic shape of the PET bottle, the AI processor may determine the object as the non-target collection object and control the inner plate 120 to rotate in the backward direction.

In the transparency analysis step, the target determination unit 200 may analyze the transparency inside the PET bottle P to determine whether the contents remain. The AI processor may analyze the transmittance of light passing through the PET bottle P or the color distribution inside the PET bottle P from the image captured by the capturing module.

When it is determined that the contents remain inside the PET bottle P, the AI processor may determine the corresponding PET bottle P as the non-target collection object and control the inner plate 120 to rotate in the backward direction.

In the surface pattern analysis step, the target determination unit 200 may analyze the surface of the PET bottle P to determine whether the label is removed. The AI processor may analyze a color distribution, a texture pattern, reflectivity, etc., of the surface of the PET bottle P from the image captured by the capturing module. In addition, the AI processor may also determine whether label adhesive remains on the surface of the PET bottle P.

When the label or adhesive is detected on the surface of the PET bottle P, the AI processor may determine the PET bottle P as the non-target collection object and control the inner plate 120 to rotate in the backward direction.

In this multi-step determination process, each step may be performed sequentially, and when the criteria set at each step are not met, the object may be immediately determined as the non-target collection object without performing analysis in the subsequent step.

In addition, the target determination unit 200 may perform multiple captures according to the rotation state of the PET bottle P.

Specifically, the AI processor may control the capturing module to capture the PET bottle P from various angles while slightly rotating the inner plate 120. This enables the analysis of the entire surface of the PET bottle P, and in particular, it may accurately determine whether the label is removed from a part of the bottom surface covered by the PET bottle P while the PET bottle P is lying down.

In this way, the target determination unit 200 may perform an all-round analysis of the PET bottle P through the micro-rotation of the inner plate 120. Specifically, the AI processor may sequentially capture the entire surface of the PET bottle P while micro-rotating the inner plate 120 by a certain angle by controlling the first driving motor 130.

The shape recognition, the transparency analysis, and the surface pattern analysis described above may be performed for each capturing, and the final determination may be performed by comprehensively evaluating a plurality of analysis results.

In this case, the target determination unit 200 may reconstruct the captured data by angle into a three-dimensional image. The AI processor may create the three-dimensional appearance of the PET bottle P by combining two-dimensional images captured from various directions, and thus, the overall shape or surface condition of the PET bottle P may be analyzed more accurately. In particular, the condition of the part covered by the bottom surface or whether the back surface of the PET bottle P, etc., is sunken may be confirmed in three dimensions.

In addition, the target determination unit 200 may apply different weights by the capturing angle. For example, a higher weight may be applied to the position where the main label of the PET bottle P is attached or the position where the barcode is printed, thereby improving the accuracy of analysis. Also, when it is difficult to make a clear determination at a specific angle, the weight of the angle may be lowered and greater weight may be given to the analysis results of other angles.

Meanwhile, the target determination unit 200 may also perform the analysis on the case where the compressed PET bottle P is input.

To this end, the AI processor may first determine whether the PET bottle P is compressed from the 3D image data acquired through micro-rotation capturing. Specifically, the AI processor may analyze the shapes of the longitudinal and cross-sectional sections of the PET bottle P to detect whether the deformation has occurred from the original cylindrical shape.

Accordingly, when the input object is determined to be the compressed PET bottle P, the AI processor may apply a corrected determination criterion considering the determination. For example, the surface pattern analysis algorithm may be adjusted so that wrinkles or unevenness formed on the surface due to the compression are not mistaken as the residue of the label. In addition, since the shape of the neck or cap of the PET bottle P remains relatively circular even in the compressed state, the overall shape analysis may be performed based on this.

In addition, the AI processor may consider the decrease in transparency due to the compression. When the PET bottle P is compressed, light scattering may occur due to the wrinkles on the surface, thereby reducing the overall transparency. Accordingly, the AI processor may correct and apply the standard value of the transparency analysis for the compressed PET bottle P and determine whether the contents remain based on the portion where the transparency is maintained locally.

So far, the preferred embodiments according to the present disclosure have been reviewed, and the fact that the present disclosure can be embodied in other specific forms without departing from the spirit or scope in addition to the above-described embodiments is obvious to those skilled in the art. Therefore, the embodiments described above are to be regarded as illustrative rather than restrictive, and thus the present disclosure is not limited to the above description, but may be modified within the scope of the appended claims and their equivalents.

### DESCRIPTION OF SYMBOLS

P: PET bottle
10: main body housing
11: inlet
12: outlet
13: discharge guide
100: sorting assembly
110: sorting housing
120: inner plate
121: detection area
130: first driving motor
131: first torque limiter
140: sensor dog
150: photo sensor array
151: fixed position photo sensor
152: export photo sensor
160: door assembly
161: slide door
162: guide rail
163: second driving motor
164: second torque limiter
165: door photo sensor
200: target determination unit
300: collection box

What is claimed is:

1. An automatic sorting and collection apparatus for target collection objects, comprising:
a main body housing that has an inlet formed so that a user inputs the target collection objects, and an outlet formed so that non-target collection objects input through the inlet are discharged;
a sorting assembly that includes an inner plate provided inside the inlet and forming a detection area in which a molten body input through the inlet is settled on an upper portion, and a first driving motor providing a driving force so that the inner plate rotates in forward and backward directions;
a target determination unit that is provided inside the main body housing to capture an object positioned in the detection area and determines whether the captured object is a target collection object; and
a collection box that is provided inside the main body housing to capture the target collection objects,
wherein the sorting assembly controls the first driving motor so that the inner plate rotates in the forward direction, based on the determination result of the target determination unit, to collect the target collection objects by dropping the target collection objects toward the collection box, and controls the first driving motor so that the inner plate rotates in the backward direction, to discharge non-target collection objects by dropping the non-target collection objects toward the outlet.

2. The automatic sorting and collection apparatus of claim 1, wherein the sorting assembly further includes:
a sensor dog that is provided at a preset position of the inner plate; and
a photo sensor array that detects a position of the sensor dog.

3. The automatic sorting and collection apparatus of claim 2, wherein the photo sensor array includes:
a fixed position photo sensor that detects the sensor dog while the inner plate is in the fixed position; and
an export photo sensor that detects the sensor dog while the inner plate rotates in the backward direction from the fixed position.

4. The automatic sorting and collection apparatus of claim 1, wherein the sorting assembly further includes a first torque limiter that is provided between the first driving motor and the inner plate to cause a motor shaft of the first driving motor to idle when an external force exceeding a preset torque value is applied.

5. The automatic sorting and collection apparatus of claim 1, further comprising:
a door assembly selectively opening and closing the inlet.

6. The automatic sorting and collection apparatus of claim 1, wherein the door assembly includes:
a slide door that is formed to be movable up and down, and shields the inlet while moving to the upper portion, and opens the inlet while moving to a lower portion;
a guide rail that provides a guide for moving the slide door up and down; and
a second driving motor that provides a driving force to move the slide door up and down along the guide rail.

7. The automatic sorting and collection apparatus of claim 6, wherein the door assembly further includes a second torque limiter that is provided between the second driving motor and the slide door to cause a motor shaft of the second driving motor to idle when an external force exceeding a preset torque value is applied.

8. The automatic sorting and collection apparatus of claim 6, wherein the door assembly further includes a pair of door photo sensors that detect upward and downward movement positions of the slide door.

9. The automatic sorting and collection apparatus of claim 1, wherein the target determination unit includes:
a capturing module that captures an object positioned in the detection area; and
an AI processor that analyzes an image captured by the capturing module to determine whether the object positioned in the detection area is the target collection object.

10. The automatic sorting and collection apparatus of claim 1, wherein the target collection object is a PET bottle with a label removed.
